(19) United States
(12) Patent Application Publication
(10) Pub. No.: US 2015/0160787 A1
(43) Pub. Date: Jun. 11, 2015

(54) CONTROLLING MULTIPLE COMPUTING SYSTEMS

(71) Applicant: International Business Machines Corporation, Armonk, NY (US)

(72) Inventors: Peter F. Haggar, Raleigh, NC (US); Jacqueline G. Rojanatavorn, Raleigh, NC (US); Steven K. Speicher, Holly Springs, NC (US); Mark E. Wallace, Black Rock (IE); Scott A. Will, Wake Forest, NC (US)

(73) Assignee: INTERNATIONAL BUSINESS MACHINES CORPORATION, Armonk, NY (US)

(21) Appl. No.: 14/102,695

(22) Filed: Dec. 11, 2013

(51) Int. Cl. G06F 3/0481; H04L 29/06

(52) U.S. Cl. CPC G06F 3/0481; H04L 65/1069

(57) ABSTRACT

Collaborating within a network computing system includes establishing a peer-to-peer communication link between a first computing system and a second computing system. The first computing system includes a first display device and a first pointer upon the display device. The second computing system includes a second display device and a second pointer upon the second display device. The second computing system receives first pointer control data for the first pointer indicating that the first pointer is to be displayed upon the second display device. The first pointer is displayed upon the second display device as specified by the first pointer control data. The second computing system moves the first pointer on the second display device responsive to second pointer control data received from the first computing system. The first pointer remains under control of the first computing system while the second pointer remains under control of the second computing system.

### BACKGROUND

In many cases, two or more persons are located in close proximity to one another with each person working on a different computing system. For example, two or more co-workers may be sitting next to one another in a same physical meeting place while working on laptops, personal computers, tablets, or the like. While collaborating with one another, a first user using a first computing system may wish to copy or obtain information displayed on the display device of a second computing system used by a second user, e.g., a co-worker or friend.

In order to transfer the desired data from the second computing system to the first computing system, the first user must ask the second user for the data. The second user then copies the data and creates a message within a communication client executing in the second computing system. The second user then pastes the data into the message, e.g., an instant message or an electronic mail, using the communication client. The second user then sends the message to the first user. Upon receipt of the message within a communication client executing within the first computing system, the first user selects the data from the message, copies the selected data, and then pastes the data into the intended destination application or location within the second computing system. This process is cumbersome and disruptive to the workflow of one or both of the users.

### SUMMARY

A method includes establishing a peer-to-peer communication link between a first computing system and a second computing system. The first computing system includes a first display device and a first pointer upon the display device controlled by the first computing system. The second computing system includes a second display device and a second pointer upon the second display device controlled by the second computing system. Within the second computing system, first pointer control data for the first pointer is received from the first computing system. The first pointer control data indicates that the first pointer is to be displayed upon the second display device. The method includes displaying the first pointer upon the second display device as specified by the first pointer control data. The first pointer is displayed upon the second display device concurrently with the second pointer. The method further includes the second computing system moving the first pointer on the second display device responsive to second pointer control data received from the first computing system. The first pointer remains under control of the first computing system while the second pointer remains under control of the second computing system.

A system includes a processor programmed to initiate executable operations. The executable operations include establishing a peer-to-peer communication link between a first computing system and a second computing system. The first computing system includes a first display device and a first pointer upon the display device controlled by the first computing system. The second computing system includes a second display device and a second pointer upon the second display device controlled by the second computing system. Within the second computing system, using the processor, first pointer control data for the first pointer is received from the first computing system. The first pointer control data indicates that the first pointer is to be displayed upon the second display device. The executable operations further include displaying the first pointer upon the second display device as specified by the first pointer control data, wherein the first pointer is displayed upon the second display device concurrently with the second pointer. The executable operations also include the second computing system moving the first pointer on the second display device responsive to second pointer control data received from the first computing system. The first pointer remains under control of the first computing system while the second pointer remains under control of the second computing system.

A computer program product includes a computer readable storage medium having program code stored thereon. The program code is executable by a processor to perform a method. The method includes establishing a peer-to-peer communication link between a first computing system and a second computing system. The first computing system includes a first display device and a first pointer upon the display device controlled by the first computing system. The second computing system includes a second display device and a second pointer upon the second display device controlled by the second computing system. The method includes, using a processor within the second computing system, receiving first pointer control data for the first pointer from the first computing system. The first pointer control data indicates that the first pointer is to be displayed upon the second display device. The method further includes displaying, using the processor, the first pointer upon the second display device as specified by the first pointer control data, wherein the first pointer is displayed upon the second display device concurrently with the second pointer. The method also includes the second computing system moving the first pointer on the second display device responsive to second pointer control data received from the first computing system using the processor. The first pointer remains under control of the first computing system while the second pointer remains under control of the second computing system.

### BRIEF DESCRIPTION OF THE SEVERAL VIEWS OF THE DRAWINGS

FIG. 1 is a block diagram illustrating an exemplary network computing system.

FIG. 2 is a block diagram illustrating exemplary architecture for a computing system.

FIG. 3 is a block diagram illustrating exemplary display devices of two computing systems communicatively linked through a peer-to-peer network.

FIG. 4 is a block diagram illustrating exemplary display devices of two computing systems communicatively linked through a peer-to-peer network.

FIG. 5 is a block diagram illustrating exemplary display devices of two computing systems communicatively linked through a peer-to-peer network.

FIG. 6 is a block diagram illustrating exemplary display devices of two computing systems communicatively linked through a peer-to-peer network.

FIG. 7 is a block diagram illustrating exemplary display devices of two computing systems communicatively linked through a peer-to-peer network.

FIG. 8 is a block diagram illustrating exemplary display devices of two computing systems communicatively linked through a peer-to-peer network.

FIG. 9 is a flow chart illustrating an exemplary method collaborating among a plurality of users.

FIG. 10 is a flow chart illustrating another exemplary method of collaborating among a plurality of users.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to creating a multi-display desktop that is operable under the control of a plurality of different computing systems to facilitate collaboration among a plurality of users of the computing systems. In accordance with the inventive arrangements disclosed herein, the display devices of two or more different computing systems can be used to form, or implement, a multi-display desktop by establishing peer-to-peer communication links among the computing systems. The plurality of display devices of the computing systems effectively behave as a single, larger desktop and implement a computing environment in which a user of one computing system is able to control another, different computing system. Multiple, different users can control a same computing system concurrently.

With peer-to-peer communication links established, linked computing systems can request permission and grant such permission for a pointer from one computing system to move to, and be displayed upon, a display device of a different computing system. For example, a pointer, i.e., a first pointer, displayed upon the display device of a first computing system can be moved to the display device of a different, e.g., a second, computing system. Pointer control data from the first computing system is sent to the second computing system. The second computing system interprets the pointer control data and moves the pointer of the first computing system upon the display device of the second computing system responsive to the received pointer control data.

A second pointer belonging to the second computing system is displayed upon the second display device concurrently with the first pointer. The second pointer remains under control of the second computing system. While the second computing system is responsible for updating the position of the first pointer on the second display device, the first pointer remains under control of the first computing system which provides the pointer control data to the second computing system for controlling the first pointer. The second computing system only interprets the pointer control data, but is not in control of the first pointer other than to interpret received pointer control data.

With the pointer of the first computing system being displayed upon the display device of the second computing system, the user of the first computing system can perform various operations on the second computing system. Such operations can be performed concurrently with any operations initiated by the user of the second computing system. For example, the user of the first computing system can perform and/or initiate operations such as selecting data, copying data, moving data, launching a program, and the like on the second computing system. It should be appreciated that the particular type of operations that the user of the first computing system is permitted to implement on the second computing system will depend upon permissions and security settings implemented within the second computing system. The user of the first computing system may perform and/or initiate any operation on the second computing system that may be initiated by the user second computing system in accordance with any security and/or permissions that may be applied.

The user of the first computing system further can initiate and/or implement the transfer and/or sharing of data from the second computing system to the first computing system. In illustration, when the first pointer is relocated back to the display device of the first computing system and is no longer displayed upon the second display device, any data copied and/or otherwise associated with the first pointer from operation upon the second display device is sent or otherwise provided from the second computing system to the first computing system.

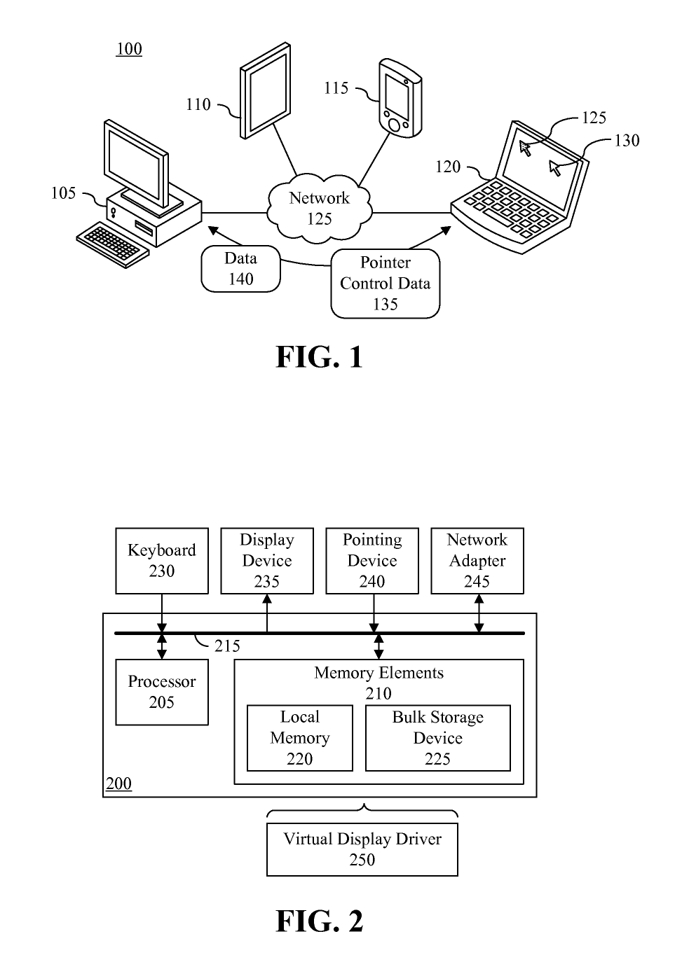

FIG. 1 is a block diagram illustrating an exemplary network computing system 100. Network computing system 100 includes computing systems 105, 110, 115, and 120. Computing systems 105, 110, 115, and 120 may be implemented as any of a variety of different computing systems, which include communication systems. For example, computing system 105 is a desktop computing system. Computing system 110 is a tablet computing system. Computing system 115 is a handheld or mobile computing system such as a mobile phone or the like. Computing system 120 is a portable computing system, e.g., a laptop. The aforementioned types of computing systems are provided for purposes of illustration only and, as such, are not intended as limitations.

Computing systems 105, 110, 115, and 120 are communicatively linked by a network 125. Network 125 is the medium used to provide communications links between various devices and computing systems connected together within network computing system 100. Network 125 may include connections, such as wire, wireless communication links, or fiber optic cables. Network 125 can be implemented as, or include, any of a variety of different communication technologies such as a wide area network (WAN), a local area network (LAN), a wireless network, Near Field Communication (NFC), a mobile network, a Virtual Private Network (VPN), Wi-Fi, Bluetooth, the Internet, the Public Switched Telephone Network (PSTN), or the like.

Through network 125, one or more or all of computing systems 105, 110, 115, and 120 are configured to establish peer-to-peer connections or communication links. As such, communication between computing systems is direct and does not involve a centralized server. Thus, for example, computing system 105 may communicate directly with communication system 110.

In one exemplary implementation, each of computing systems 105, 110, 115, and 120 is located within a defined and/or limited geographic area. For example, computing systems 105, 110, 115, and 120 may be located within a same room or a same office space. The users (not shown) of computing systems 105, 110, 115, and 120 may be collaborating with one another and positioned so that each user can view the display device of the computing system used by that user as well as the display device of one, two, or the remainder of the other computing systems. For example, the user of computing system 105 can be physically positioned to view the display device of computing system 105. Further, the user of computing system 105 can view the display device of computing system 110, the display devices of computing systems 110 and 115, or the display devices of computing systems 110, 115, and 120.

In one aspect, in establishing a communication link between two or more of computing systems 105, 110, 115, and 120, such computing systems can facilitate the movement of a pointer from the display device of one computing system to the display device of any other of the computing systems that have granted access for pointer sharing. For example, computing system 105 requests permission from computing system 120 to allow the pointer of computing system 105, shown as pointer 125, to move to the display device of computing system 120 and initiate operations within computing system 120. Computing system 120 grants such access to computing system 105.

For example, each of computing systems 105, 110, 115, and 120 can be executing suitable software that allows each computing system to detect other computing systems within a predefined geographic range and request and/or grant access. In one aspect, each computing system can detect other computing systems using a first communication technology and subsequently perform pointer sharing operations over the same communication technology. For example, proximity of other computing systems may be determined by each respective computing system using NFC, infrared communication links, Bluetooth, or the like. Subsequently, pointer control operations involving the transfer of data 140 and/or pointer control data 135 may be transferred using the same peer-to-peer communication link using the same technology used to determine proximity.

In another aspect, computing systems can detect other computing systems using a first communication technology and subsequently perform pointer sharing operations using a second, different communication technology. For example, proximity detection may be performed using infrared, while subset pointer sharing operations are performed over Bluetooth or Wi-Fi. The particular communication technology used to determine whether other computing systems are proximate for implementing shared pointer access as described within this disclosure may be different from the particular communication technology used to transfer information such as data items, objects, visualizations, pointer control data, or the like.

In the example pictured in FIG. 1, pointer 125 of computing system 105 has moved to, and is displayed upon, the display device of computing system 120. Pointer 125 is displayed concurrently with pointer 130, which is the pointer of computing system 120. It should be appreciated that while pointer 130 is shown on the display device of computing system 120, pointer 130 may be moved to the display device of any other computing system that has granted access for pointer sharing to computing system 120. Presuming, for example, that each of computing systems 105, 110, and 115 has granted access to computing system 120, the user of computing system 120 can move pointer 130 to any other one of the display devices of computing systems 105, 110, and 115.

As used within this disclosure, “pointer control data” means data relating to the operation of a pointer including movement, scrolling, clicking, dragging, dropping, and/or other events and/or operations that can be initiated and/or performed by a pointer, requests for access of a pointer for display upon a display device of a different computing system, and grants of access to a pointer of a different computing system than the computing system having provided such a grant. Pointer control data further can include data generated by another peripheral such as a keyboard. As shown in FIG. 1, computing system 105 submits pointer control data 135 to computing system 120. For example, by virtue of particular movements of a pointing device of computing system 105 controlling pointer 125, the user of computing system 105 causes computing system 105 to request permission for pointer 125 to move to the display device of computing system 120 via the sending of pointer control data 135. Computing system 120 grants access to computing system 105 via the sending of pointer control data 135 back to computing system 105.

Once pointer 125 is displayed upon the display device of computing system 120, the user of computing system 105 can select and copy data 140 upon the display device of computing system 120 using pointer 125. The user of computing system 105 may control one or more aspects of computing system 120 using pointer 125. Control of computing system 120 by the user of computing system 105 is concurrent with control of computing system 120 by the user of computing system 120. Responsive to pointer 125 moving back to the display device of computing system 105, data 140 is transferred, or sent, from computing system 120 to computing system 105. As noted, communication between computing devices, whether for pointer control data 135 and/or data 140, is communicated via the peer-to-peer communication links or connections. Further aspects of the inventive arrangements are described with reference to the remaining figures. As discussed, data 140 and/or pointer control data 135 may be transferred over a communication link such as BlueTooth, NFC, Wi-Fi, or any other network technology over which a peer-to-peer communication link may be established. Such communication link may be different from the communication technology used to determine whether two or more computing devices are proximate to one another, to request access, and to grant access.

FIG. 2 is a block diagram illustrating exemplary architecture for computing system (system) 200. The architecture described with reference to FIG. 2 may be used to implement any of a variety of different computing systems including any of those described with reference to FIG. 1, i.e., computing systems 105, 110, 115, and/or 120. System 200 includes at least one processor, e.g., a central processing unit (CPU), 205 coupled to memory elements 210 through a system bus 215 or other suitable circuitry. As such, system 200 can store program code within memory elements 210. Processor 205 executes the program code accessed from memory elements 210 via system bus 215 or the other suitable circuitry.

In one aspect, system 200 is implemented as a computer or other programmable data processing apparatus or system that is suitable for storing and/or executing program code. It should be appreciated, however, that system 200 can be implemented in the form of any system including a processor and memory that is capable of performing and/or initiating the functions and/or operations described within this disclosure. Further, system 200 can be implemented in any of a variety of different form factors including, but not limited to, a portable device such as a mobile communication device, a tablet computing and/or communication device, a laptop computing device, a desktop computing device, a server, or the like.

Memory elements 210 include one or more physical memory devices such as, for example, local memory 220 and one or more bulk storage devices 225. Local memory 220 refers to RAM or other non-persistent memory device(s) generally used during actual execution of the program code. Bulk storage device(s) 225 can be implemented as a hard disk drive (HDD), solid state drive (SSD), or other persistent data storage device. System 200 also can include one or more cache memories (not shown) that provide temporary storage of at least some program code in order to reduce the number of times program code must be retrieved from bulk storage device 225 during execution.

Input/output (I/O) devices such as a keyboard 230, a display device 235, and a pointing device 240 optionally can be coupled to system 200. Exemplary pointing devices 235 include, but are not limited to, track pads, track balls, mice, touchscreens which are integrated with display device 235, etc. Exemplary display devices 235 include flat screen monitors using any of a variety of different technologies, e.g., plasma, LED, LCD, etc., conventional CRT monitors, and the like. The I/O devices can be coupled to system 200 either directly or through intervening I/O controllers.

One or more network adapters 245 also can be coupled to system 200 to enable system 200 to become coupled to other systems, computer systems, remote printers, and/or remote storage devices through intervening private or public networks. Modems, cable modems, wireless transceivers, infrared transceivers, NFC transceivers, and Ethernet cards are examples of different types of network adapters 245 that can be used with system 200 to detect other proximate computing systems and/or to establish peer-to-peer communication links with other computing systems.

As pictured in FIG. 2, memory elements 210 can store a virtual display driver 250. Virtual display driver 250, being implemented in the form of executable program code, is executed by system 200 and, as such, is considered an integrated part of system 200. Virtual display driver 250, when executed, can cause system 200 to perform and/or initiate the various operations and/or programmatic actions described within this specification. Accordingly, virtual display driver 250, including any parameters and/or attributes utilized by virtual display driver 250, are functional data structures that impart functionality when employed as part of system 200. System 200 can perform and/or initiate the various operations described within this disclosure in cooperation with one or more other suitably configured computing system(s) also executing a virtual display driver where the computing systems are communicatively linked over a network as described.

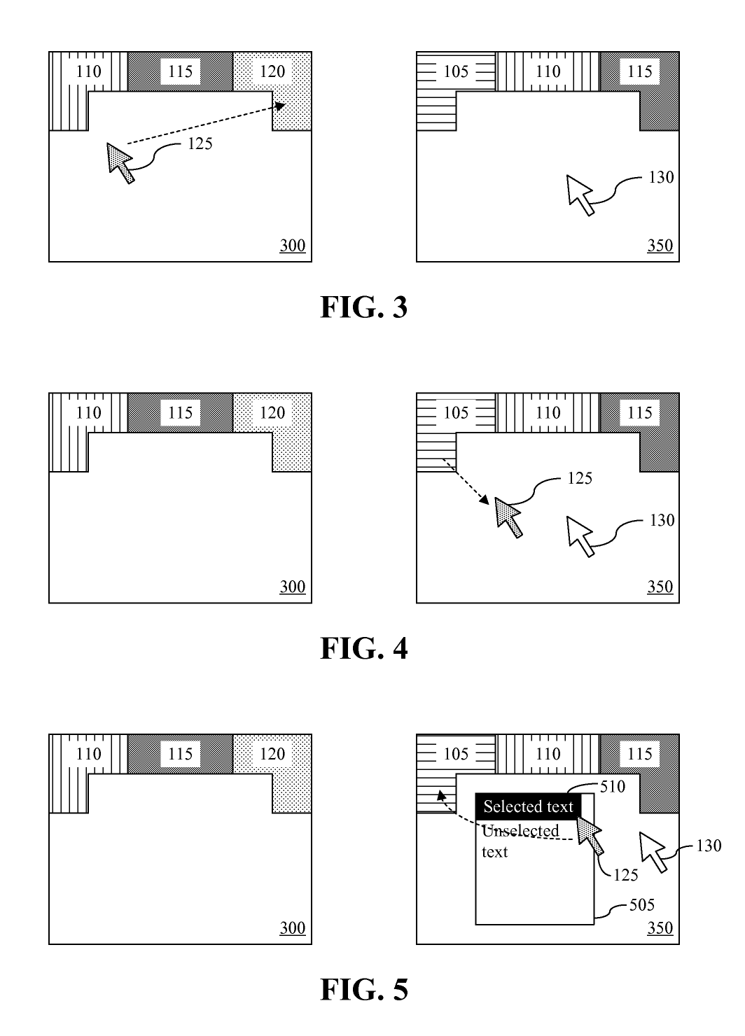

FIG. 3 is a block diagram illustrating exemplary display devices of two computing systems communicatively linked through a peer-to-peer network. More particularly, FIG. 3 illustrates a display device 300, which is the display device of computing system 105 of FIG. 1, and a display device 350, which is the display device of computing system 120 of FIG. 1. Pointer 125 is the pointer for computing system 105 and is displayed upon display device 300. As used within this specification, the term “displayed” or the phrase “displayed upon” means that the item is shown or rendered as visible to a user, e.g., a human being, by a display device. Pointer 130 is the pointer for computing system 120 and displayed upon display device 350.

Display device 300 includes three regions labeled 110, 115, and 120. Each region represents a computing system that may be asked to grant access for moving pointer 125 thereto or which has already granted access. Region 110 on display device 300 is associated with computing system 110. Region 115 on display device 300 is associated with computing system 115. Region 120 on display device 300 is associated with computing system 115. In one aspect, regions 110, 115, and 120 are generated or overlaid upon a view presented upon display device 300 by the virtual display adapter executed by computing system 105.

Display device 350 includes three regions labeled 105, 110, and 115. Again, each region represents a computing system that may be asked to grant access for moving pointer 130 thereto or which has already granted access. Region 105 on display device 350 is associated with computing system 105. Region 110 on display device 350 is associated with computing system 110. Region 115 on display device 350 is associated with computing system 115. In one aspect, regions 105, 110, and 115 are generated or overlaid upon a view presented upon display device 350 by the virtual display adapter executed by computing system 120.

Each of regions 105, 110, 115, and 120 can be rendered or displayed with one or more distinctive, visual characteristics and/or attributes that are indicative of particular computing system represented by each respective region. Within FIG. 3, for example, each of regions 105, 110, 115, and 120 has distinctive shading to differentiate the region from another region associated with a different computing system. This allows the user of each computing system to easily determine which region on the display screen is associated with which other computing system available to the user. Any of a variety of different visual characteristics can be used such as shading, color, labels, and/or any combination of the foregoing so that each region is visually distinctive from each other region. Further, when a pointer enters, exits, or is within a given region, a visual characteristic of the region can be changed responsive to that condition to indicate that a pointer is within, has entered, and/or exited a particular region. For example, the region can be made to blink or flash or change color or shade responsive to a pointer being located within, entering, or exiting the region.

The user of computing system 105 moves a pointing device causing pointer 125 to move into region 120. Responsive to detection of pointer 125 within region 120, computing system 105 sends pointer control data for pointer 125 to computing system 120. In one aspect, the pointer control data includes a request for access. Computing system 120 may grant or deny the request. In another aspect, in the case where access has already been granted by computing system 120 to computing system 105, the pointer control data indicates that pointer 125 is leaving display device 300 and should be displayed upon display device 350.

FIG. 4 is a block diagram illustrating exemplary display devices of two computing systems communicatively linked through a peer-to-peer network. FIG. 4 continues the example described with reference to FIG. 3. More particularly, FIG. 4 illustrates the state of display devices 300 and 350 after pointer 125 enters region 120. Responsive to pointer 125 being detected within region 120, pointer 125 is displayed upon display device 350. For example, pointer 125 can emerge from region 105 upon display device 350 and continue to move in accordance with any further pointer control data received by computing system 120 from computing system 105. As pictured, pointer 125 is no longer visible or displayed upon display device 300. Rather, both pointer 125 and pointer 130 are displayed concurrently upon display device 350.

Referring to FIG. 4, pointer 130 remains under control of computing system 120. More particularly, pointer 130 continues to be controlled by the pointing device of computing system 120. Pointer 125 is controlled by the pointing device of computing system 105. Pointer control data generated by the pointing device of computing system 105 is sent via the virtual display driver from computing system 105 to computing system 120. Computing system 120, e.g., the virtual display driver executing therein, interprets the pointer control data received from computing system 105 thereby allowing computing system 120 to render or draw pointer 125 upon display device 350. Further movement and control of pointer 125 while displayed upon display device 350 is responsive to further pointer control data sent from computing system 105.

FIG. 5 is a block diagram illustrating exemplary display devices of two computing systems communicatively linked through a peer-to-peer network. FIG. 5 continues with the previous example of FIG. 4 where pointer 125 is displayed upon display device 350. In the example of FIG. 5, an object 505 is also displayed. For purposes of illustration, object 505 may be a document or a window including text. As shown, pointer 125 has selected a portion of text 510 responsive to pointer control data received by computing system 120 from computing system 105. The pointer control data, for example, can specify location information for pointer 125, a clicking event, and continued click with movement selecting text 510. FIG. 5 illustrates the case where the user of computing system 105 is able to select a data item such as text 510 from display device 350. It should be appreciated that while the conveyance of pointer control data is described as occurring in one or more instances, pointer control data may be continually sent from one computing system to another and/or sent periodically.

In another aspect, the user of computing system 105 initiates actions causing text 510 to be copied. For example, the user of computing system 105, having selected text 510, may access a menu displayed by display device 350 to execute or invoke a copy command in computing system 120. In another aspect, the user of computing system 105 may use the keyboard of computing system 105 to initiate a copy command. In either case, the copy command can be provided from computing system 105 to computing system 120 as pointer control data, which causes computing system 120 to copy text 510. Text 510 is copied by computing system 120 by storing the selected text within memory within computing system 120. For example, text 510 may be stored in the clipboard of computing system 120. Text 510 is stored in association with pointer 125 to differentiate data items and/or objects stored in consequence of actions of pointer 125 from items stored in consequence of actions of pointer 130.

Having copied text 510 to memory, pointer 125 is moved responsive to further pointer control data from computing system 105 to region 105 in display device 350. Detection of pointer 125 within region 105 of causes pointer 125 to be moved back to computing system 105. For example, computing system 120 notifies computing system 105 that pointer 125 is returning for display upon display device 300. In that case, computing system 105 discontinues sending pointer control data to computing system 120. Accordingly, pointer 125 is no longer displayed upon display device 350 and is instead displayed upon display device 300. For example, pointer 125 can be shown to exit from region 120 upon display device 300. Further, detection of pointer 125 within region 105 of display device 350 causes computing system 120 to select any data items stored in memory that are associated with pointer 125 and send such data items to computing system 105. Thus, text 510 is identified within memory of computing system 120 as being associated with pointer 125 and is sent by computing system 120 to computing system 105. In one aspect, the data received by computing system 105 from computing system 120 is stored in the clipboard of computing system 105.

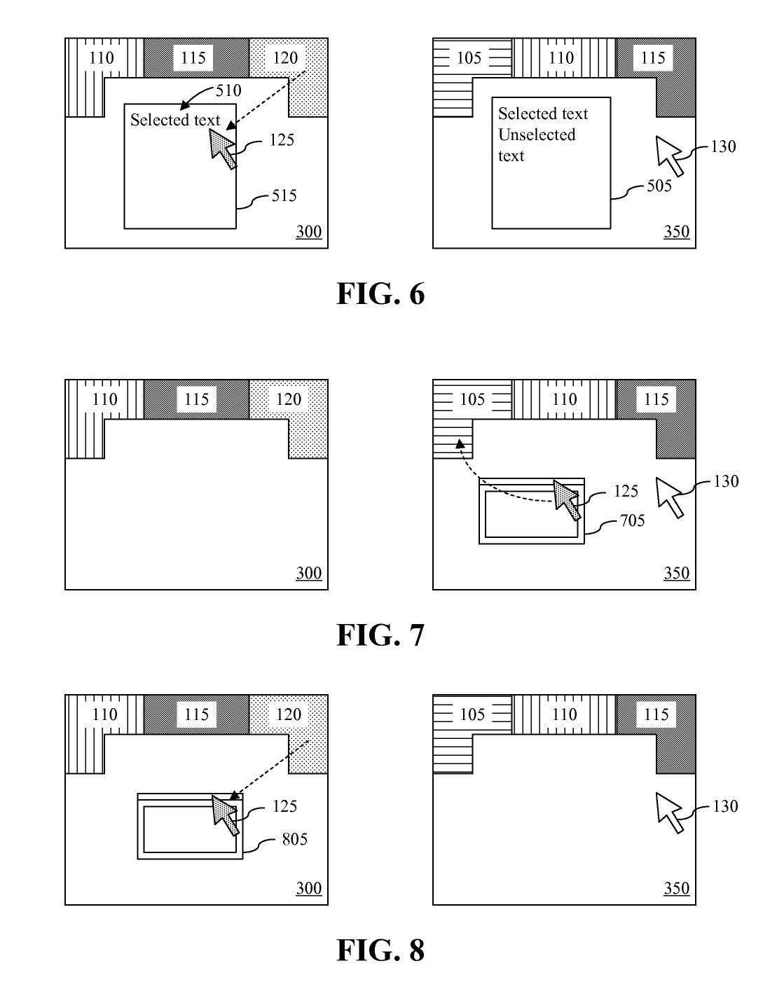

FIG. 6 is a block diagram illustrating exemplary display devices of two computing systems communicatively linked through a peer-to-peer network. FIG. 6 continues the example of FIG. 5 where pointer 125 is again displayed upon display device 300, while pointer 130 is displayed upon display device 350. As illustrated, pointer 125 emerges from region 120 upon display device 300. In the example shown, the user of computing system 105 has positioned pointer 125 over an open document 515 and initiated a paste command. As pictured, text 510, which was copied from the display of computing system 120 using pointer 125, is inserted into document 515 at a location specified by pointer 125.

More particularly, data sent from computing system 120 is stored within the clipboard, e.g., in memory, of computing system 105. Accordingly, when the user of computing system 105 initiates a paste command, the pointer control data for pointer 125 is now executed by computing system 105 and not computing system 120. As such, the contents of the clipboard of computing system 105, e.g., text 510, is inserted or pasted at the location of pointer 125 responsive to the command. In one aspect, the paste command is implemented by a keyboard. in another aspect, the paste command is implemented by pointer 125 and text 510 is inserted at a location of a cursor within document 515.

FIG. 7 is a block diagram illustrating exemplary display devices of two computing systems communicatively linked through a peer-to-peer network. FIG. 7 illustrates an example where pointer 125 is displayed within display device 350 and selects an object 705. In the example of FIG. 7, object 705 is a window of a program executing within computing system 120. The program may be an operating system level file viewer or browser, a word processing program, other application program or operating system utility, or the like. In any case, pointer 125 drags object 705 into region 105 upon display device 350. Responsive to pointer 125 dragging object 705 into region 105, pointer 125 is no longer displayed upon display device 350, is displayed upon display device 300. Further, visualization data specifying a visualization of object 705 is sent from computing system 120 to computing system 105.

FIG. 8 is a block diagram illustrating exemplary display devices of two computing systems communicatively linked through a peer-to-peer network. FIG. 8 continues with the example described with reference to FIG. 7. As shown, pointer 125 is no longer displayed upon display device 350. Pointer 125, for example, can emerge from region 120 dragging visualization 805. Accordingly, pointer 125 is now displayed upon display device 300 along with visualization 805. In general, computing system 105 generates visualization 805 from the visualization data provided from computing system 120. Visualization 805 is a picture, e.g., a visual representation, of object 705 displayed upon display device 300.

In one aspect, computing system 105 need not execute the same program that is executing in computing system 120 that generated object 705 in order to generate visualization 805. Rather, computing system 105 renders visualization data provided from computing system 120 at a location specified by pointer 125 upon display device 300.

The user of computing system 105 can initiate operations by the program executing in computing system 120 by initiating particular pointer events in the region of visualization 805 upon display device 300. For example, pointer 125 can implement operations such as right clicks, left clicks, scrolling up or down, resizing, dragging, dropping, typing, and the like over visualization 805. Computing system 105 collects the pointer control data corresponding to any such actions performed over the region of visualization 805 and sends the pointer control data to computing system 120.

Computing system 120 correlates the location of the various events sent as part of the pointer control data with a functional user interface element of object 705 and initiates processing by the executing application within computing system 120. For example, a location selected by pointer 125 in visualization 805 can be mapped to a user interface element of object 705 for initiating a copy operation. The location and pointer event is communicated to computing system 120 and processed by the application that generates object 705 in computing system 120. Any resulting data, including a change in the appearance of object 705 can be provided to computing system 105 as updated visualization data. Computing system 105 can update visualization 805 in accordance with the updated visualization data received from computing system 120. It should be appreciated that some particular items of pointer control data for pointer 125, such as movement of visualization 805 in and around the view of display device 300 need not be communicated to computing system 120 since such operations are handled by computing system 105 and do not involve processing by the application program executing in computing system 120 that generates object 705.

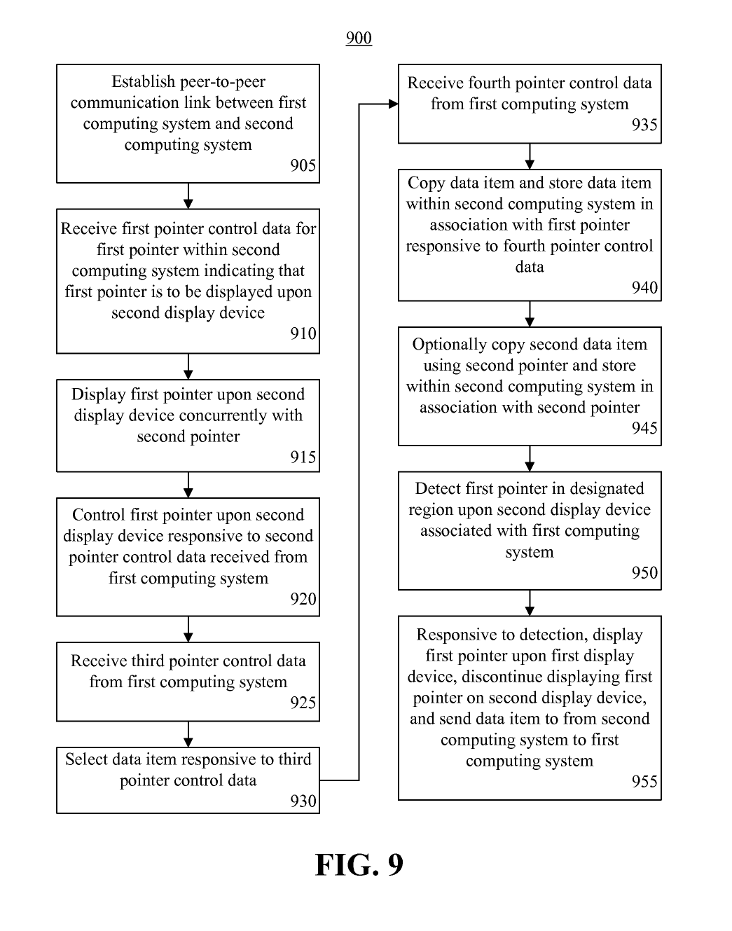

FIG. 9 is a flow chart illustrating an exemplary method 900 of collaborating among a plurality of users. Method 900 can be implemented by a network computing system including two or more computing systems as described within this disclosure. The computing systems of the network computing system further are configured as described within this disclosure.

Method 900 can begin in block 905 where a peer-to-peer communication link is established between a first computing system and a second computing system. The first computing system includes a first display device and a first pointer that can be displayed upon the first display device. The second computing system includes a second display device and a second pointer that can be displayed upon the second display device.

In block 910, the second computing system receives first pointer control data for the first pointer. The first pointer control data can indicate that the first pointer is to be displayed upon the second display device. In one aspect, the first pointer control data specifies a request for permission for the first pointer to be displayed upon the second display device. As discussed, the second computing system may accept or reject such a request. In another aspect, the second computing system has already granted permission for the first pointer to be displayed upon the second display device. Accordingly, the first pointer control data can specify any of a variety of pointer event data such as movement, location, scrolling, clicks, etc., for the first pointer.

In block 915, the second computing system displays the first pointer on the second display device. The first pointer is displayed upon the second display device concurrently with the second pointer.

In block 920, the first pointer is moved and operated upon the second display device responsive to second pointer control data received from the first computing system. For example, the second computing system interprets the second pointer control data and moves the first pointer upon the second display device as specified by the received third pointer data. It should be appreciated that while the first pointer is effectively drawn and thus moved by the second computing system upon the second display device, the movement, or control, of the first pointer still is still resides with the first computing system since the first computing system is sending pointer control data to the second computing system. The second pointer, which is displayed concurrently upon the second display device with the first pointer, remains under control of the second computing system. Accordingly, the user of the first computing system can perform operations in the second computing system using the first pointer while user of the second computing system also may perform operations in the second computing system using the second pointer. Two (or more) different users may implement operations on a same computing system using their respective pointers without involvement of a centralized server.

In block 925, the second computing system receives third pointer control data from the first computing system. For example, the third pointer control data can specify one or more pointer operations that, when implemented, cause the first pointer to select a data item displayed upon the display device of the second computing system. Accordingly, in block 930, the second computing system selects the data item using the first pointer.

In block 935, the second computing system receives fourth pointer control data from the first computing system. For example, the fourth pointer control data can specify a copy operation. In block 940, the second computing system copies the data items selected in block 930 by the first pointer. The selected data item(s) are stored within the second computing system in association with the first pointer responsive to reception of the fourth pointer control data.

In block 945 a second data item optionally can be copied and stored within the second computing system. The second data item is copied and stored using the second pointer. As such, when stored within the second computing system, the second data item is stored in association with the second pointer. As discussed, data items that are copied may be stored within a portion of memory referred to as the clipboard of the computing system. In some cases the clipboard is configured to store multiple data items. Each data item stored within the clipboard is associated with the particular pointer used to copy the data item. Accordingly, data items copied to the clipboard using the first pointer can be distinguished from data items copied to the clipboard using the second pointer.

In block 950, the second computing system detects the first pointer within a designated region of the second display device. The designated region of the second display device is associated with the first computing system. In block 955, responsive to detection of the first pointer within the designated region of the second display device, the second computing system discontinues display of the first pointer upon the second display device. In addition, the first pointer is displayed upon the first display device. For example, the second computing system notifies the first computing system that the first pointer is leaving the second display device and returning to the first display device. Accordingly, the first computing system stops sending pointer control data to the second computing system.

The second computing system identifies any data items that were copied and/or stored within the second computing system and associated with the first pointer. The second computing system sends the data items associated with the first pointer to the first computing system. The identification and subsequent sending of data items associated with the first pointer are sent responsive to detection of the first pointer within the designated region of the second display device.

In another example, the user of the first computing system can perform a past operation of the selected data to a location, e.g., into a field and/or open document, of the second computing system displayed upon the second display device. As discussed, because data items are stored in memory in association with the pointer that initiated the storage of the data item(s), the user of the first computing system is able to paste data items copied by the first pointer independently and without interfering with the pasting of data items copied by the second pointer whether such paste operation occurs in the first or the second computing system.

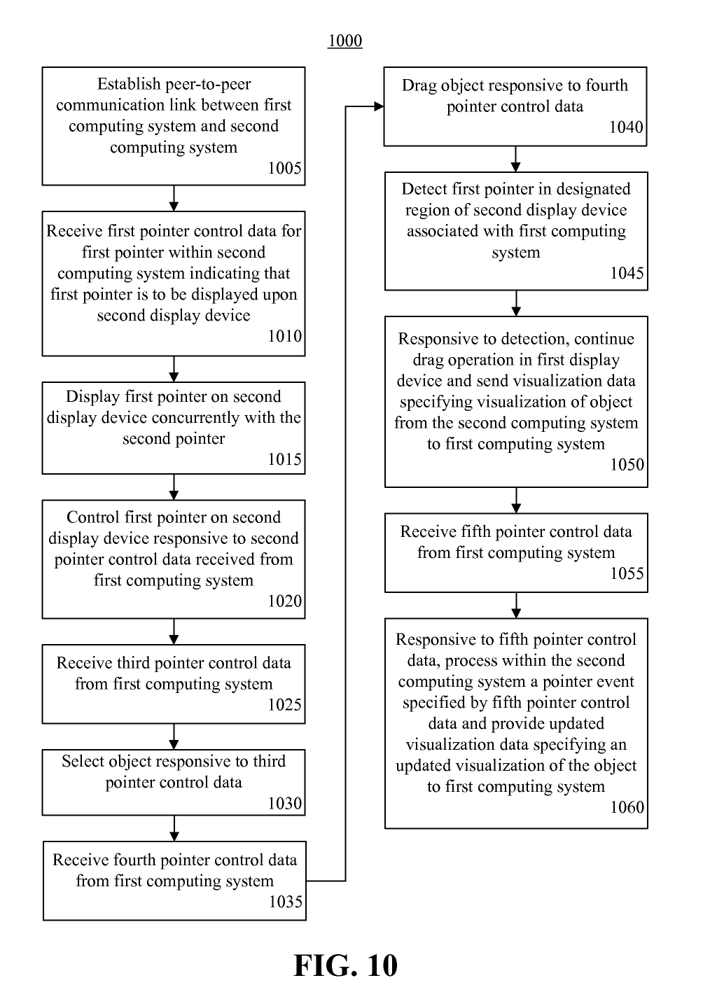

FIG. 10 is a flow chart illustrating another exemplary method 1000 of collaborating among a plurality of users. Method 1000 can be implemented by a network computing system including two or more computing systems as described within this disclosure. The computing systems of the network computing system further are configured as described within this disclosure. Blocks 1005, 1010, 1015, and 1020 of method 1000 are substantially the same as blocks 905, 910, 915, and 920, respectively, of method 900. As such, blocks 1005, 1010, 1015, and 1020 are not described again.

In block 1025, the second computing system receives third pointer control data from the first computing system. For example, the third pointer control data can specify one or more pointer operations that, when implemented, cause the first pointer to select an object displayed upon the second display device. Accordingly, in block 1030, the second computing system selects the object using the first pointer. As discussed, in another aspect, the object is a window of an executing computing program, whether an operating system level computer program, an application level computer program, or the like.

In block 1035, the second computing system receives fourth pointer control data from the first computing system. For example, the fourth pointer control data can specify a drag operation of the object selected in block 1030. In block 1040, the second computing system performs the drag operation of the selected object using the first pointer upon the second display device. In block 1045, the second computing system detects the first pointer within a designated region of the second display device. The designated region of the second display device is associated with the first computing system. For example, the first pointer has dragged the selected object into the designated region of the second display device.

In block 1050, responsive to detecting the first pointer in the designated region of the second display device, the drag operation is continued to the first display device. Further, the second computing system sends visualization data specifying a visualization of the selected object to the first computing system. In one aspect, continuing the drag operation to the first display device means that display of the first pointer on the second display device is discontinued. Further, the first pointer is displayed on the first display device dragging the visualization specified by the visualization data received by the first computing system from the second computing system.

In one aspect, in continuing the drag operation from the second display device to the first display device, the selected object may be removed from the second display device. In another aspect, the selected object may be displayed upon the second display device while the visualization of the object is displayed upon the first display device. In that case, the object, as displayed upon the second display device may be rendered with one or more identifying features indicating that the first pointer has dragged a visualization of the object to the first display device and that the program code responsible for rendering the object in the second computing system is responsive to pointer control data of the first pointer.

In block 1055, the second computing system receives fifth pointer control data from the first computing system. The first computing system is configured to continue sending pointer control data to the second computing system despite the first pointer being displayed upon the first display device. Such is the case while the first display device displays the visualization of the object.

In block 1060, responsive to fifth pointer control data, the second computing system processes a pointer event specified by the fifth pointer control data. The second computing system provides updated visualization data specifying an updated visualization of the object.

It should be appreciated that the particular operations that the user of one computing system is permitted to implement on a different computing system will depend upon permissions and security settings implemented within each different computing system. The various operations described within this disclosure are presented as examples only and, as such, are not to be interpreted as limitations. A user of a computing system, for example, may perform any operation upon a different computing system that the user of the different computing system is permitted to implement, so long as any applicable permissions and/or security settings allow such operation. Such operations may be implemented using a pointer moving from one display device to another as described within this disclosure.

In addition, the security settings and permissions can be user specific and computing system specific. As an example of user specific settings, the user of a first computing system may be permitted to implement different operations upon a second computing system than are permitted for the user of the second computing system. The operations that may be implemented by the user of the first computing system upon the second computing system further may be different from the operations that are permitted for a user of a third computing system upon the second computing system. As an example of computing system specific settings, the user of the first system may be permitted to initiate operations upon the second computing system that differ from those permitted on the third computing system.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. As defined herein, the term “computer readable storage medium” means a storage medium that contains or stores program code for use by or in connection with an instruction execution system, apparatus, or device. As defined herein, a “computer readable storage medium” is not a transitory propagating signal per se. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

The term “processor” means at least one hardware circuit (e.g, an integrated circuit) configured to carry out instructions contained in program code. Examples of a processor include, but are not limited to, a central processing unit (CPU), an array processor, a vector processor, a field-programmable gate array (FPGA) and a controller. As defined herein, the term “automatically” means without user intervention. As defined herein, the term “user” means a person (i.e., a human being).

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
establishing a peer-to-peer communication link between a first computing system and a second computing system, wherein the first computing system comprises a first display device and a first pointer upon the display device controlled by the first computing system, and wherein the second computing system comprises a second display device and a second pointer upon the second display device controlled by the second computing system;
within the second computing system, receiving first pointer control data for the first pointer from the first computing system, wherein the first pointer control data indicates that the first pointer is to be displayed upon the second display device;
displaying the first pointer upon the second display device as specified by the first pointer control data, wherein the first pointer is displayed upon the second display device concurrently with the second pointer; and
the second computing system moving the first pointer on the second display device responsive to second pointer control data received from the first computing system;
wherein the first pointer remains under control of the first computing system while the second pointer remains under control of the second computing system.

2. The method of claim 1, wherein the first pointer is not displayed on the first display device while displayed on the second display device.

3. The method of claim 1, further comprising:
responsive to third pointer control data received from the first computing system, the second computing system selecting a first data item upon the second display device indicated by the first pointer and storing the first data item within the second computing system in association with the first pointer.

4. The method of claim 3, further comprising:
selecting a second data item upon the second display device indicated by the second pointer under control of the second computing system; and
storing the second data item in the second computing system in association with the second pointer.

5. The method of claim 3, wherein responsive to detecting that the first pointer is located within a designated region upon the second display device, wherein the designated region of the second display device is associated with the first computing system, the method further comprises:
displaying the first pointer upon the first display device;
discontinuing display of the first pointer upon the second display device; and
sending the first data item from the second computing system to the first computing system.

6. The method of claim 1, further comprising:
responsive to third pointer control data received from the first computing system, selecting an object upon the second display device indicated by the first pointer, wherein the object is for a program executing in the second computing system; and
moving the object upon the second display device using the first pointer responsive to fourth pointer control data from the first computing system.

7. The method of claim 6, wherein responsive to detecting that the first pointer is located within a designated region of the second display device, wherein the designated region of the second display device is associated with the first computing system, the method further comprises:
displaying the first pointer upon the first display device;
discontinuing display of the first pointer upon the second display device; and
sending visualization data specifying a visualization of the object from the second computing system to the first computing system.

8. The method of claim 7, further comprising:
receiving fifth pointer control data from the first computing system, wherein the fifth pointer data specifies a pointer event within a region of the first display device corresponding to the visualization of the object;
responsive to receiving the fifth pointer control data, the second computing system processing the pointer event using the program; and
providing updated visualization data from the second computing system to the first computing system, wherein the updated visualization data specifies an updated visualization of the object.

9. A system, comprising:
a processor programmed to initiate executable operations comprising:
establishing a peer-to-peer communication link between a first computing system and a second computing system, wherein the first computing system comprises a first display device and a first pointer upon the display device controlled by the first computing system, and wherein the second computing system comprises a second display device and a second pointer upon the second display device controlled by the second computing system;
within the second computing system, using the processor, receiving first pointer control data for the first pointer from the first computing system, wherein the first pointer control data indicates that the first pointer is to be displayed upon the second display device;
displaying the first pointer upon the second display device as specified by the first pointer control data, wherein the first pointer is displayed upon the second display device concurrently with the second pointer; and
the second computing system moving the first pointer on the second display device responsive to second pointer control data received from the first computing system;
wherein the first pointer remains under control of the first computing system while the second pointer remains under control of the second computing system.

10. The system of claim 9, wherein the first pointer is not displayed on the first display device while displayed on the second display device.

11. The system of claim 9, wherein the processor is further programmed to initiate executable operations comprising:
responsive to third pointer control data received from the first computing system, the second computing system selecting a first data item upon the second display device indicated by the first pointer and storing the first data item within the second computing system in association with the first pointer.

12. The system of claim 11, wherein the processor is further programmed to initiate executable operations comprising:
selecting a second data item upon the second display device indicated by the second pointer under control of the second computing system; and
storing the second data item in the second computing system in association with the second pointer.

13. The system of claim 11, wherein responsive to detecting that the first pointer is located within a designated region upon the second display device, wherein the designated region of the second display device is associated with the first computing system, wherein the processor is further programmed to initiate executable operations comprising:
displaying the first pointer upon the first display device;
discontinuing display of the first pointer upon the second display device; and
sending the first data item from the second computing system to the first computing system.

14. The system of claim 9, wherein the processor is further programmed to initiate executable operations comprising:
responsive to third pointer control data received from the first computing system, selecting an object upon the second display device indicated by the first pointer, wherein the object is for a program executing in the second computing system; and
moving the object upon the second display device using the first pointer responsive to fourth pointer control data from the first computing system.

15. The system of claim 14, wherein responsive to detecting that the first pointer is located within a designated region of the second display device, wherein the designated region of the second display device is associated with the first computing system, the processor is further programmed to initiate executable operations comprising:
displaying the first pointer upon the first display device;
discontinuing display of the first pointer upon the second display device; and
sending visualization data specifying a visualization of the object from the second computing system to the first computing system.

16. The system of claim 15, wherein the processor is further programmed to initiate executable operations comprising:
receiving fifth pointer control data from the first computing system, wherein the fifth pointer data specifies a pointer event within a region of the first display device corresponding to the visualization of the object;
responsive to receiving the fifth pointer control data, the second computing system processing the pointer event using the program; and
providing updated visualization data from the second computing system to the first computing system, wherein the updated visualization data specifies an updated visualization of the object.

17. A computer program product comprising a computer readable storage medium having program code stored thereon, the program code executable by a processor to perform a method comprising:
establishing a peer-to-peer communication link between a first computing system and a second computing system, wherein the first computing system comprises a first display device and a first pointer upon the display device controlled by the first computing system, and wherein the second computing system comprises a second display device and a second pointer upon the second display device controlled by the second computing system;
using a processor within the second computing system, receiving first pointer control data for the first pointer from the first computing system, wherein the first pointer control data indicates that the first pointer is to be displayed upon the second display device;
displaying, using the processor, the first pointer upon the second display device as specified by the first pointer control data, wherein the first pointer is displayed upon the second display device concurrently with the second pointer; and
the second computing system moving the first pointer on the second display device responsive to second pointer control data received from the first computing system using the processor;
wherein the first pointer remains under control of the first computing system while the second pointer remains under control of the second computing system.

18. The computer program product of claim 17, wherein the first pointer is not displayed on the first display device while displayed on the second display device.

19. The computer program product of claim 17, wherein the method further comprises:
responsive to third pointer control data received from the first computing system, the second computing system selecting a first data item upon the second display device indicated by the first pointer and storing the first data item within the second computing system in association with the first pointer.

20. The computer program product of claim 19, wherein the method further comprises:
selecting a second data item upon the second display device indicated by the second pointer under control of the second computing system; and
storing the second data item in the second computing system in association with the second pointer.
